(19) United States
(12) Patent Application Publication
(10) Pub. No.: US 2011/0191941 A1
(43) Pub. Date: Aug. 11, 2011

(54) HAT WITH FLEXIBLE SPEAKER

(76) Inventors: Dar-Ming Chiang, Hsinchu City (TW); Shu-Ru Lin, Taichung County (TW); Yan-Ren Chen, Taichung County (TW); Shen-Long Liang, Hsinchu County (TW); I-Chen Lee, Hsinchu County (TW)

(21) Appl. No.: 12/703,780

(22) Filed: Feb. 11, 2010

(51) Int. Cl. A42B 1/24; H04R 1/00

(52) U.S. Cl. 2/209.13; 381/333

(57) ABSTRACT

A hat having a crown and a brim is provided. A flexible speaker is disposed in or on the brim. The flexible speaker includes a first flexible electrode and a second flexible electrode used for receiving an audio signal. A first electret and a second electret are disposed between the first and the second flexible electrode. A conductive layer is disposed between the first electret and the second electret. After the audio signal is input into the first flexible electrode and the second flexible electrode, the first electret, the second electret and the conductive layer are driven to vibrate.

### BACKGROUND OF THE INVENTION

1. Field of the Invention

The present invention relates to a hat with an audio device, and more particularly, to a hat with a flexible speaker.

2. Description of the Prior Art

Portable audio devices such as CD players, MP3 players have become popular in recent years, and are used in a variety of ways. For example, exercise fans use portable radios with earphones to listen to radio broadcasts while exercising. Sports fans use portable radios at live games to listen to radio broadcasts of the game while viewing the game from the stands. Portable radios are configured so that large headphones substantially cover a user's ears. Smaller headphones are anchored inside the user's ear canals.

Increasing use of portable devices can have certain inherent dangers. A person wearing headphones cannot always hear the horn of a car or a warning shout. Another worry is that the headphones could damage a listener's hearing.

Therefore, a long-standing need has existed to provide a novel speaker to solve the above-mentioned problem.

### SUMMARY OF THE INVENTION

In light of the above, it is one objective of the present invention to provide a hat with a flexible speaker. The hat includes a flexible speaker disposed in or on the brim of the hat. The flexible speaker includes a first flexible electrode to receive an audio signal, a second flexible electrode to receive the audio signal, a first electret positioned between the first flexible electrode and the second flexible electrode, a second electret positioned between the first flexible electrode and the second flexible electrode and a conductive layer positioned between the first electret and the second electret, wherein the first electret, the second electret and the conductive layer are driven to vibrate after the first flexible electrode and the second flexible electrode receive the audio signal.

It is another objective of the present invention to provide another hat with a flexible speaker. The hat has a flexible speaker positioned on the brim of the hat, wherein the flexible speaker comprises: a flexible electrode to receive a audio signal, an electret adjacent to the flexible electrode and a conductive layer positioned on the electret, wherein the flexible electrode and the conductive layer are driven to vibrate after the flexible electrode receives the audio signal.

The flexible speaker of the present invention is foldable. Therefore, a hat made of soft material can still be folded even with the flexible speaker on it. Furthermore, the flexible speaker is light and thin, and can therefore attach to the brim of the hat conformally without deteriorating the hat's profile.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts schematically a hat with a flexible speaker according to a first preferred embodiment of the present invention.

FIG. 2 depicts a sectional view of the flexible speaker of the present invention.

FIG. 3 depicts a sectional view of the flexible speaker along the line A-A′ shown in FIG. 2.

FIG. 4 shows a variation of the flexible speaker of the present invention.

FIG. 5 depicts schematically a hat with a flexible speaker according to a second preferred embodiment of the present invention.

FIG. 6 depicts schematically a hat with a flexible speaker according to a third preferred embodiment of the present invention.

FIG. 7 depicts schematically a hat with a flexible speaker according to a fourth preferred embodiment of the present invention.

FIG. 8 depicts schematically a hat with a flexible speaker according to a fifth preferred embodiment of the present invention.

FIG. 9 depicts schematically a ring-shaped accessory formed by a flexible speaker according to a sixth preferred embodiment of the present invention.

### DETAILED DESCRIPTION

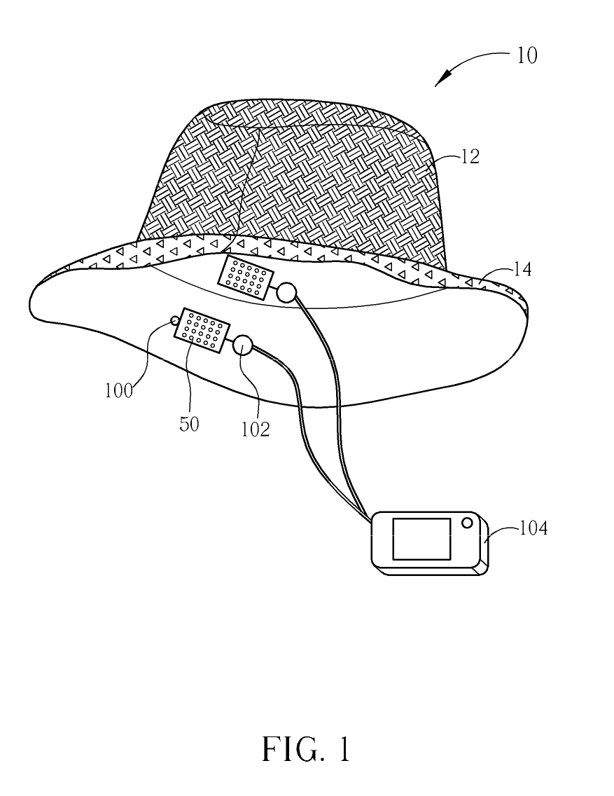

FIG. 1 depicts schematically a hat with a flexible speaker according to a first preferred embodiment of the present invention. As shown in FIG. 1, a bucket hat 10 includes a crown 12 and a brim 14 surrounding the crown 12. A flexible speaker 50 is positioned in or on the brim 14. For example, the flexible speaker 50 can be sewed on the lining of the brim 14, or the flexible speaker 50 can be attached on the brim 14 by a fixer 100 such as a button, a magnet or a Velcro fastener.

In addition, the flexible speaker 50 is connected to an amplifier 102 for inputting signal(s). The amplifier 102 can also be disposed in the brim 14 or on the brim 14, or even can be put on the crown 12. The amplifier 102 is connected to an audio signal producer 104 such as CD player, an MP3 player, or a radio.

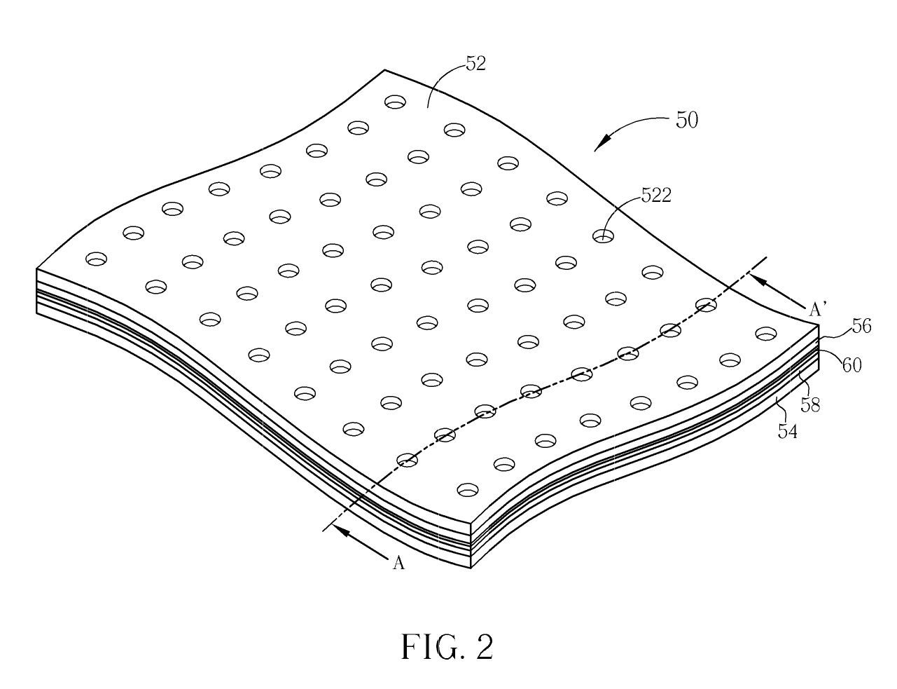

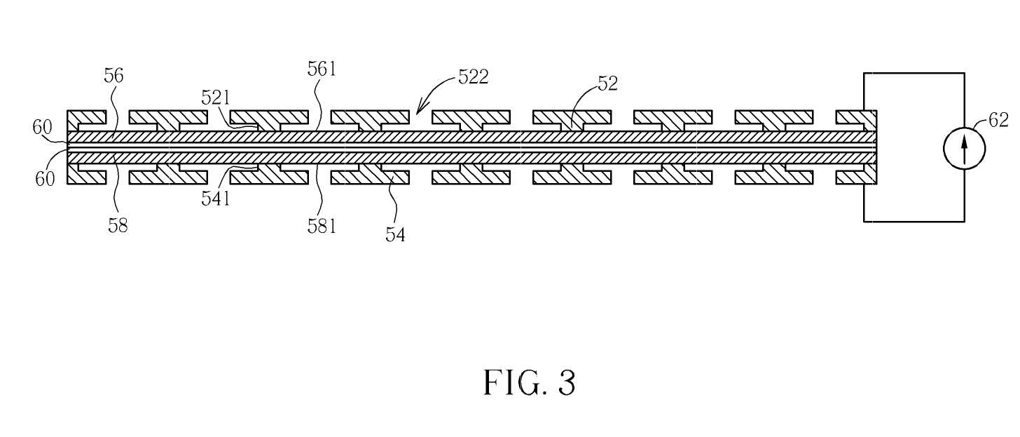

FIG. 2 depicts a sectional view of the flexible speaker of the present invention. FIG. 3 depicts a sectional view of the flexible speaker along the line A-A′ shown in FIG. 2. As shown in FIG. 2 and FIG. 3, a flexible speaker 50 includes a first flexible electrode 52 and a second flexible electrode 54, a first electret 56 positioned between the first flexible electrode 52 and the second flexible electrode 54, a second electret 58 positioned between the first flexible electrode 52 and the second flexible electrode 54, and a conductive layer 60 positioned between the first electret 56 and the second electret 58. The conductive layer 60 is attached on the first electret 56 and the second electret 58 respectively.

The first flexible electrode 52 and the second flexible electrode 54 are used to receive an audio signal 62. After receiving the audio signal 62, the first flexible electrode 52 and the second flexible electrode 54 will drive the first electret 56, the second electret 58 and the conductive layer 60 to vibrate relative to the first flexible electrode 52 and the second flexible electrode 54. Then, the vibration of the first electret 56, the second electret 58 and the conductive layer 60 will constitute sounds. A plurality of spacers 521 are positioned between the first flexible electrode 52 and a surface 561 of the first electret 56. A plurality of spacers 541 are positioned between the second flexible electrode 54 and a surface 581 of the second electret 58. The spacer 521, 581 provide adequate surface tension to the first electret 56 and the second electret 58. In addition, the first flexible electrode 52 and the second flexible electrode 54 both have a plurality of openings 522 to serve as acoustic passages.

The first electret 56 and the second electret 58 may include one or more dielectric materials selected from fluorinated ethylene propylene (FEP), polyterafluoroethylene (PTFE), polyvinylidene fluoride (PVDF), polyethylene (PE), polypropylene (PP), polyimide (PI), cyclic olefin copolymers (COC), fluorine-containing polymers or composites thereof. After the aforesaid dielectric materials are electrized, the dielectric materials may be positively charged with electric holes or negatively charged with electrons, and the dielectric materials can serve as the first electret 56 and the second electret 58.

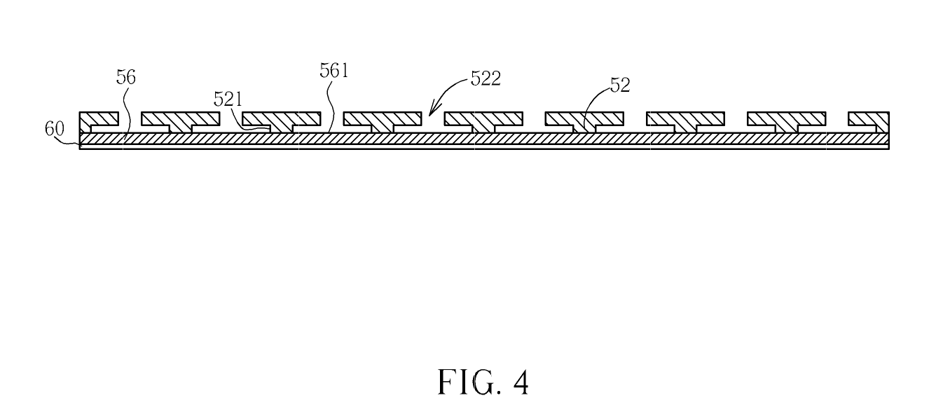

FIG. 4 shows a variation of the flexible speaker of the present invention. As shown in FIG. 4, according to another preferred embodiment of the present invention, the second electret 58 and the second flexible electrode 54 can be optionally disposed in the flexible speaker 50. That is, the flexible speaker 50 is only composed of the first flexible electrode 52, the first electret 56 and the conductive layer 60. In this embodiment, the conductive layer 60 serves as another electrode, and drives the first electret 56 together with the first flexible electrode 52.

The flexible speaker in the present invention is simple and low cost. In particular, the flexible speaker is foldable, light and thin. Therefore, the flexible speaker can attach to a hat without destroying the hat's appearance.

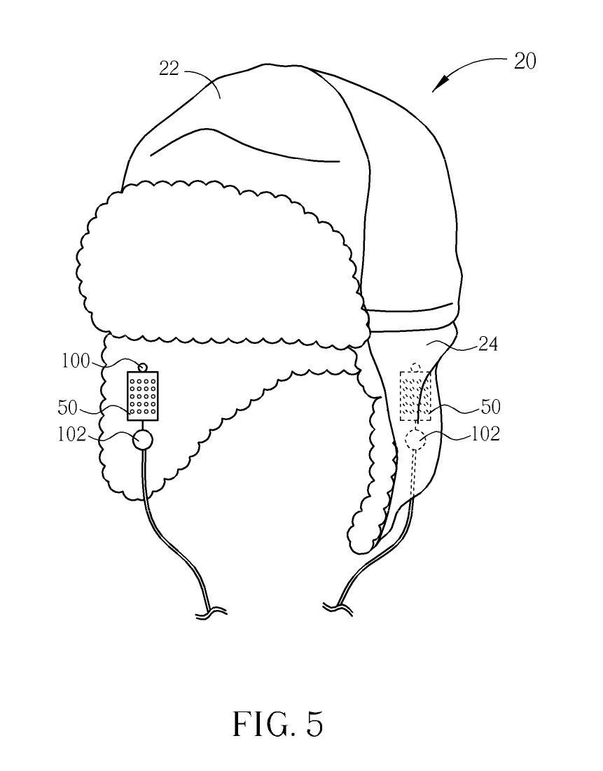

The following FIG. 5-9 demonstrate other applications of the flexible speaker, wherein elements with the same function will be designated with the same numerals as in FIG. 1 and FIG. 2.

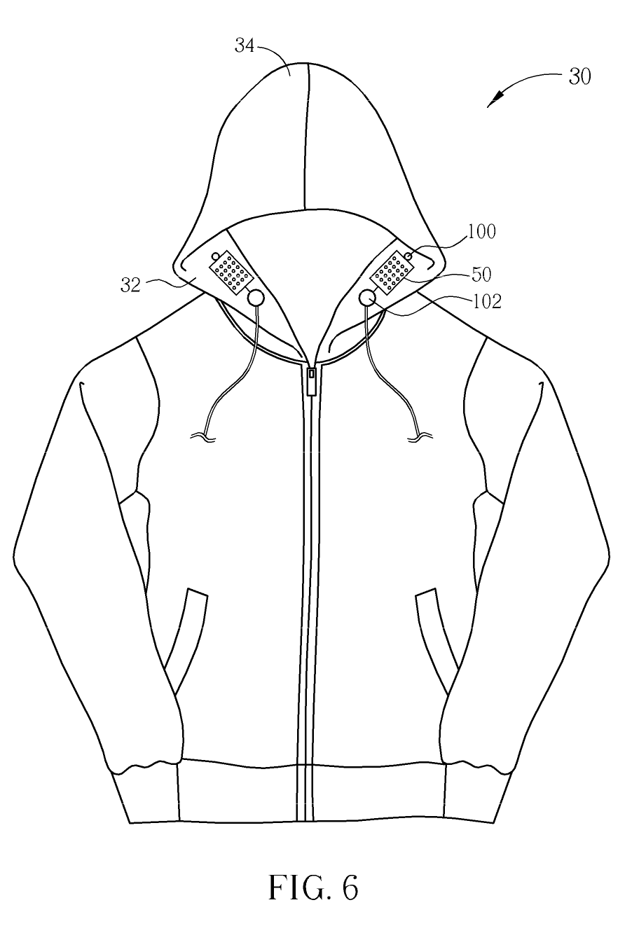

FIG. 5 depicts schematically a hat with a flexible speaker according to a second preferred embodiment of the present invention. As shown in FIG. 5, a bomber cap 20 has a crown 22 and a brim 24. The flexible speaker 50 can be positioned at the brim 24 covering a wearer's ears. In this way, a better sound performance can be provided. FIG. 6 depicts schematically a hat with a flexible speaker according to a third preferred embodiment of the present invention. As shown in FIG. 6, a hoodie jacket 30 has a crown 34 and a brim 32. The flexible speaker 50 can be positioned at the brim 32 of the hoodie jacket 30.

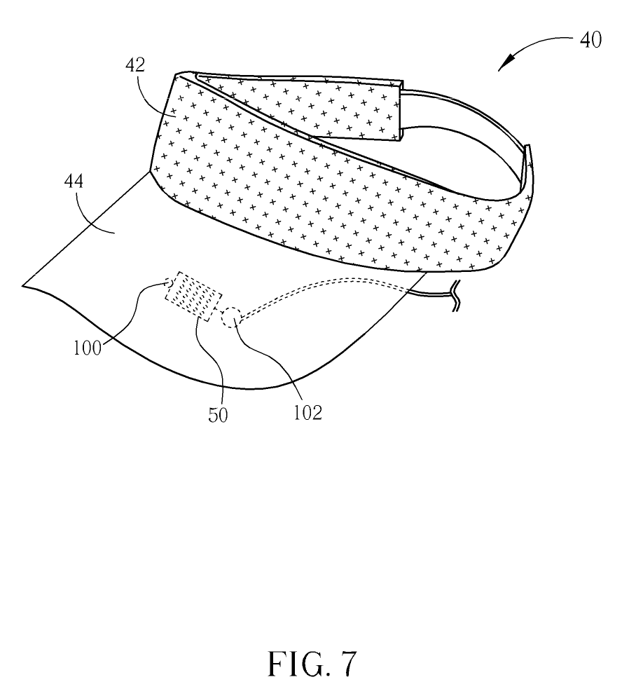

FIG. 7 depicts schematically a hat with a flexible speaker according to a fourth preferred embodiment of the present invention. As shown in FIG. 7, a visor 40 has a crown 42 and a brim 44. The flexible speaker 50 can be positioned at the brim 44 of the visor 40.

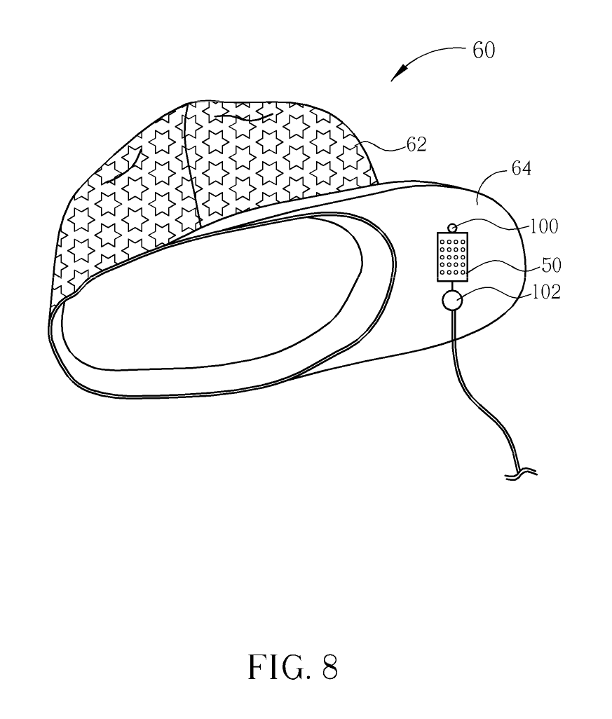

FIG. 8 depicts schematically a hat with a flexible speaker according to a fifth preferred embodiment of the present invention. As shown in FIG. 8, a fitted cap 60 has a crown 62 and a brim 64. The flexible speaker 50 can be positioned at the brim 64 of the fitted cap 60.

The flexible speaker of the present invention can be disposed on or in a soft brim such as in the bucket hat, the bomber cap, and the hoodie jacket illustrated respectively in FIGS. 1, 5 and 6. The flexible speaker can also be disposed in or on a hard brim such as the visor and the fitted cap described in FIGS. 7 and 8, respectively. Of course, the flexible speaker can also be applied to other hats.

The conventional electrostatic speaker uses a thin flat diaphragm consisting of a plastic sheet impregnated with a conductive material for vibration. The diaphragm is fixed on a hard frame. The backplate electrode of the electrostatic speaker is made of hard materials. Therefore, the electrostatic speaker is not flexible and not foldable because of the frame and the backplate electrode. Moreover, the electrostatic speaker is heavier and bigger than the eletret speaker. This means the electrostatic speaker is not suitable to be put on headwear. The flexible speaker (electret speaker) of the present invention, however, can be folded. Therefore, even when attaching the flexible speaker to a soft hat, the hat can still be folded to a small size. In addition, if the flexible speaker is attached on a hat with a hard brim such as a visor, a fitted cap, or a helmet, the flexible speaker can be attached on the hat conformally.

The flexible speaker is light and thin, allowing the wearer to wear the hat with the flexible speaker without discomfort. Unlike conventional earphones, the flexible speaker sits close to the ears, not in the ear canals, and therefore will not damage a user's hearing.

The flexible speaker of the present invention can be combined with blue tooth. Furthermore, the flexible speaker can also function as an audio receiver such as a microphone. If the flexible speaker functions as an audio receiver, the audio signal producer should be replaced by an audio signal recorder.

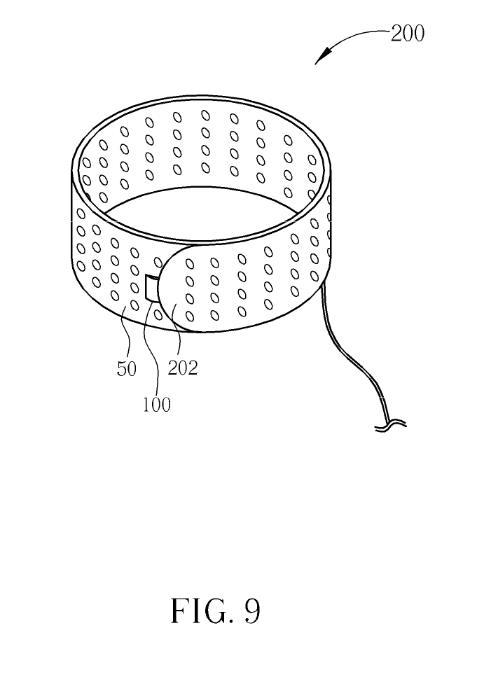

FIG. 9 depicts schematically a ring-shaped accessory formed by a flexible speaker according to a sixth preferred embodiment of the present invention. As shown in FIG. 9, a ring-shaped accessory 200 includes a wrapper 202, a flexible speaker 50 disposed in the wrapper 202, and a fixer 100 disposed on the wrapper 202. The flexible speaker 50 can be bent into a ring shape and be fixed on a wearer's arm, wrist, ankle, or neck. The flexible speaker 50 forms a continuous structure surrounding the limb of a wearer in all-directions.

Those skilled in the art will readily observe that numerous modifications and alterations of the device and method may be made while retaining the teachings of the invention.

What is claimed is:

1. A hat with flexible speaker, comprising:
a hat comprising a crown and a brim adjacent to the crown;
a flexible speaker disposed on the brim, wherein the flexible speaker comprises:
a first flexible electrode to receive an audio signal;
a second flexible electrode to receive the audio signal;
a first electret positioned between the first flexible electrode and the second flexible electrode;
a second electret positioned between the first flexible electrode and the second flexible electrode; and
a conductive layer positioned between the first electret and the second electret, wherein the first electret, the second electret and the conductive layer are driven to vibrate after the first flexible electrode and the second flexible electrode receive the audio signal.

2. The hat with flexible speaker of claim 1, wherein the flexible speaker is positioned in the brim.

3. The hat with flexible speaker of claim 1, wherein the brim covers a wearer's ears.

4. The hat with flexible speaker of claim 1, further comprising a fixer for fastening the flexible speaker on the brim.

5. The hat with flexible speaker of claim 4, wherein the fixer comprises a Velcro fastener.

6. The hat with flexible speaker of claim 4, wherein the fixer comprises a button.

7. The hat with flexible speaker of claim 4, wherein the fixer comprises a magnet.

8. The hat with flexible speaker of claim 1, wherein the hat is selected from the group consisting of a visor, a bucket hat, a bomber cap, a hoodie jacket, and a fitted cap.

9. The hat with flexible speaker of claim 1, wherein the flexible speaker is connected to an amplifier.

10. The hat with flexible speaker of claim 9, wherein the amplifier is positioned in the brim.

11. The hat with flexible speaker of claim 10, wherein the amplifier is connected to an audio signal producer.

12. The hat with flexible speaker of claim 11, wherein the audio signal producer comprises an IPOD, a CD player, a MP3 player, or a radio.

13. The hat with flexible speaker of claim 1, wherein the first electret comprises at least a first dielectric layer having charges.

14. The hat with flexible speaker of claim 13, wherein the first electric layer is selected from the group consisting of fluorinated ethylene propylene (FEP), polyterafluoroethylene (PTFE), polyvinylidene fluoride (PVDF) and fluorine-containing polymers.

15. The hat with flexible speaker of claim 1, wherein the second electret comprises at least a second dielectric layer having charges.

16. The hat with flexible speaker of claim 15, wherein the second electric layer is selected from the group consisting of fluorinated ethylene propylene (FEP), polyterafluoroethylene (PTFE), polyvinylidene fluoride (PVDF) and fluorine-containing polymers.

17. A hat with flexible speaker, comprising:
a hat comprising a crown and a brim adjacent to the crown; and
a flexible speaker positioned on the brim, wherein the flexible spacer comprises:
a flexible electrode to receive an audio signal;
an electret adjacent to the flexible electrode; and
a conductive layer positioned on the electret, wherein the flexible electrode and the conductive layer are driven to vibrate after the flexible electrode receives the audio signal.
